(19) United States
(12) Patent Application Publication
(10) Pub. No.: US 2018/0219190 A1
(43) Pub. Date: Aug. 2, 2018

(54) ENERGY STORAGE SYSTEM, METHOD FOR OPERATING AN ENERGY STORAGE SYSTEM, AND METHOD FOR PRODUCING AN ENERGY STORAGE SYSTEM

(71) Applicant: Airbus Operations GmbH, HAMBURG (DE)

(72) Inventor: Peter Linde, Buxtehude (FR)

(21) Appl. No.: 15/881,981

(22) Filed: Jan. 29, 2018

(30) Foreign Application Priority Data
Jan. 30, 2017 (DE) 102017201406.7

(51) Int. Cl. H01M 2/02; H01M 10/42; H01M 10/48; H01M 2/06

(52) U.S. Cl. CPC H01M 2/024; H01M 10/425; H01M 2220/20; H01M 2/06; H01M 10/48

(57) ABSTRACT

An energy storage system, a method for operating the energy storage system, and a method for producing an energy storage system. The energy storage system comprises a housing having a laminated energy storage structure and at least one connector, disposed in the housing, for an energy storage element or a group of energy storage elements

### CROSS-REFERENCES TO RELATED APPLICATIONS

This application claims the benefit of the German patent application No. 10 2017 201 406.7 filed on Jan. 30, 2017, the entire disclosures of which are incorporated herein by way of reference.

### TECHNICAL FIELD

The invention relates to an electrical energy storage system, in particular an electrical energy storage system for vehicle construction, in particular for aircraft construction or for space travel, or for use in a vehicle, in particular in an aircraft or in a spacecraft. The invention furthermore relates to a method for operating an electrical energy storage system, and to a method for producing an electrical energy storage system.

### BACKGROUND OF THE INVENTION

In many vehicles, in particular in air travel or space travel, there are high demands with respect to energy storage density of energy storage devices, i.e., there is to be a capability to store as much electrical energy as possible per unit of weight of the energy storage device. Energy storage devices may be understood to mean, for example, batteries, and preferably rechargeable accumulators, for example for use in electric or hybrid vehicles. The energy storage density (or energy density) is measured, for example, in watt-hours per kilogram (Wh/kg).

The publication U.S. Pat. No. 9,276,240 B2 describes a flat, laminated battery arrangement, of which the side faces are smaller than the front faces.

Furthermore, there are demands with respect to the structural elements of vehicles, for example that they can carry a particular weight, must withstand a particular pressure, and the like. Structural elements are, for example, housings, which are designed to protect elements located in the housing (such as, for example, energy storage elements) against external influences such as impacts. Such structural elements usually add greatly to the weight of the respective vehicle.

US 2002/0004167 A1 describes a shell, integrated in which there is a battery.

### SUMMARY OF THE INVENTION

Proceeding from this known prior art, one of the objects of the present invention is to provide an improved energy storage system, in particular, an energy storage system having a higher energy density.

The present invention relates, in one aspect, to an energy storage system having a housing that has a laminated energy storage structure, and having at least one connection means or conector, disposed in the housing, for an electrical energy storage element or for a group of electrical energy storage elements.

A housing is to be understood to mean, in particular, a fixed shell that protects the connection means and, if applicable, electrical energy storage elements connected to the connection means, for example against impacts or against aggressive or corrosive fluids from outside. The housing may fully enclose the connection means.

The housing may be composed entirely or partly of the laminated energy storage structure. A laminated energy storage structure is to be understood to mean, in particular, a structure that is realized from at least two, preferably at least three, joined layers, and that is suitable for storing electrical energy.

The housing preferably has at least one electrical connection, by means of which the laminated energy storage structure can be charged with electrical energy and/or via by means of which electrical energy can be drawn from the laminated energy storage structure.

The connection means are designed or set up to electrically and/or mechanically connect the energy storage elements or the groups of energy storage elements. The energy storage system may additionally comprise one or more energy storage elements, or groups of electrical energy storage elements, connected to the at least one connection means.

The electrical energy storage elements or groups of electrical energy storage elements may be electrically and mechanically connected in a fixed and/or permanent manner to the connection means.

An energy storage system is thus provided that has a particularly high energy storage density, since, instead of a housing that is realized as a purely structural element, a housing is used that serves simultaneously as an energy storage structure. Consequently, overall, the ratio of a maximally storable energy quantity to a weight of the system is improved.

By this means, on the one hand, a greater quantity of energy can be stored, with a weight of the energy storage system remaining the same overall. Alternatively, weight can advantageously be saved, with an energy storage quantity remaining the same. Furthermore, it is possible to achieve an optimum balance, of a high storable energy quantity and a low weight of the energy storage system that can be adapted according to a specific field of application of the energy storage system.

Furthermore, advantageously, signal processing and/or sensor functions may be integrated in the housing realized as an energy storage structure.

According to a further aspect, the invention relates to a method for producing an energy storage system, having the steps: providing a housing that has a laminated energy storage structure; and arranging or attaching at least one connection means for an energy storage element or a group of energy storage elements in the housing. The production method may comprise the step: connecting at least one energy storage element or a group of energy storage elements to the at least one connection means.

Advantageous embodiments and developments are given by the further dependent claims and by the description with reference to the figures.

According to some embodiments, the laminated energy storage structure has a cathode layer, at least one anode layer, and an insulator layer disposed between the cathode layer and the at least one anode layer.

According to some embodiments, at least one anode layer has carbon fibers and/or a synthetic resin, or has carbon-fiber reinforced synthetic resin, or is composed of carbon-fiber reinforced synthetic resin.

According to some embodiments, the cathode layer has a ferrite, or is composed of a ferrite. The cathode layer may have a ferrite, carbon fibers and/or a synthetic resin. According to some embodiments, the cathode layer has a carbon-fiber reinforced synthetic resin having a fiber coating of ferritic oxide, or is composed of a carbon-fiber reinforced synthetic resin having a fiber coating of ferritic oxide.

According to some embodiments, the insulator layer has glass fibers and/or a synthetic resin, or has glass-fiber reinforced synthetic resin, or is composed of glass-fiber reinforced synthetic resin.

According to some embodiments, the energy storage system comprises a switching means, by means of which the at least one connection means can be connected, both electrically in parallel and electrically in series, to the laminated energy storage structure. A current delivered by the energy storage system, or a voltage delivered by the energy storage system, can thus be varied in an efficient and reliable manner.

According to some embodiments, the energy storage system comprises a control means, by means of which the switching means can be controlled on the basis of an input signal that can indicate, for example, a demand for current and/or voltage. An existing demand for current and/or voltage can thus be covered as accurately and efficiently as possible by the energy storage system.

The above embodiments and developments can be combined with each other in any manner, insofar as appropriate. Further possible embodiments, developments and implementations of the invention comprise combinations, including those not explicitly mentioned, of features of the invention described previously or in the following with respect to the exemplary embodiments. In particular, in this case persons skilled in the art will also add individual aspects as improvements or supplements to the respective basic form of the present invention.

### BRIEF DESCRIPTION OF THE DRAWINGS

The present invention is described in greater detail in the following on the basis of the exemplary embodiments specified in the schematic figures. There are shown in

FIGS. 1 and 1a, a schematic representation of an energy storage system according to an embodiment of the present invention;

FIG. 2, a schematic block diagram of an energy storage system according to a further embodiment of the present invention; and

FIG. 3, a schematic flow diagram to explain a method for producing an energy storage system according to a further embodiment of the present invention.

The accompanying figures are intended to impart further understanding of the embodiments of the invention. They illustrate embodiments and, in conjunction with the description, serve to explain principles and concepts of the invention. Other embodiments and many of the stated advantages are disclosed with respect to the drawings. The elements of the drawings are not necessarily shown true to scale in relation to each other. Terminology that specifies direction, such as, for instance, “up,” “down,” “left,” “right,” “over,” “under,” “horizontal,” “vertical,” “front,” “rear” and similar specifications are used merely for explanatory purposes, and do not serve to limit the generality to specific embodiments as shown in the figures.

In the figures of the drawing—unless otherwise stated—elements, features and components that are the same, functionally the same and have the same action are in each case denoted by the same references.

### DETAILED DESCRIPTION OF THE PREFERRED EMBODIMENTS

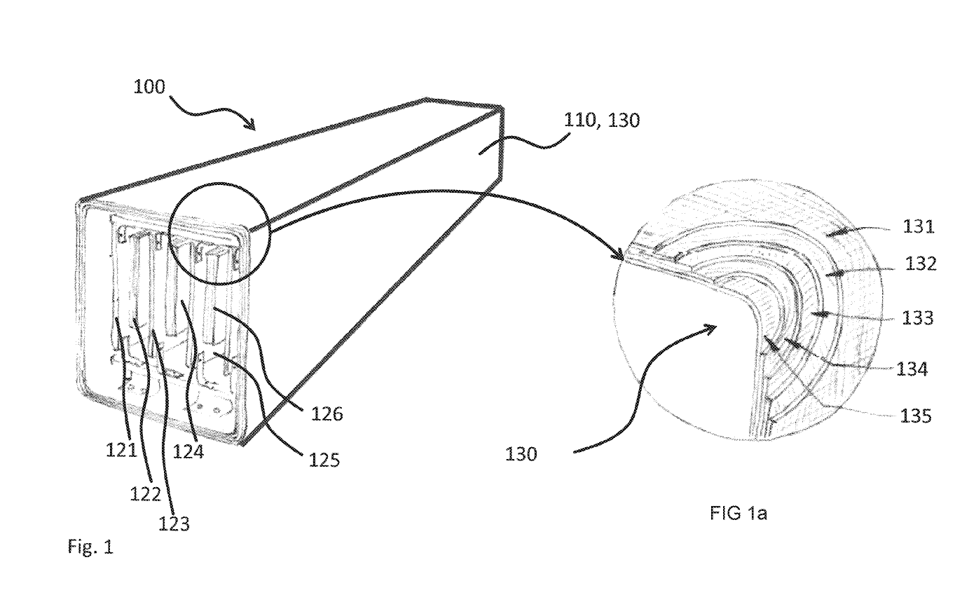

FIGS. 1 and 1a are a schematic representation of an energy storage system 100 according to an embodiment of the present invention, wherein an overall view is shown on the left in FIG. 1, and a detail view is represented on the right in FIG. 1a. The energy storage system 100 comprises a housing 110 of a laminated electrical energy storage structure 130. In other words, the housing 110 is advantageously formed only from the laminated energy storage structure 130.

The laminated electrical energy storage structure 130 is preferably shaped with at least one corner and/or edge and/or curvature to form the housing 110.

The detail view on FIG. 1a shows one of the corners of the housing 110 for the purpose of explaining the energy storage structure 130, individual layers of the energy storage structure 130 being represented schematically, partly cut open.

According to FIGS. 1 and 1a, there are three connection means 121, 123, 125 disposed, in particular fitted or installed, in the housing 110. It is understood that, instead of precisely three connection means 121, 123, 125, there may also be only one or two, or also four or even more, connection means 121, 123, 125 disposed, in particular fitted or installed, in the housing 110.

Each connection means 121, 123, 125 may be designed and configured or set up to electrically and/or mechanically connect respectively one energy storage element 122, 124, 126, or also respectively one group of energy storage elements. Some connection means may also be disposed, in particular fitted or installed, in the housing for the purpose of connecting individual energy storage elements, and some connection means disposed, in particular fitted or installed, in the housing for the purpose of connecting respectively a group of energy storage elements.

As shown in FIG. 1a, the laminated energy storage structure 130 advantageously has a cathode layer 131, at least one anode layer 133, 134, 135, and an insulator layer 132 disposed between the cathode layer 131 and the at least one anode layer 133, 134, 135. Preferably, all provided anode layers 133, 134, 135 are spaced apart from the cathode layer 131 by the insulator layer 132.

The cathode layer 131 preferably has a ferrite (or ferritic oxide), or is composed of a ferrite (or ferritic oxide), in particular in a woven or braided form, or in the form of a mesh.

The insulator layer 132 serves to electrically insulate the cathode layer 131 from the at least one anode layer 133, 134, 135 as a dielectric. Preferably, the insulator layer 132 has glass fibers and/or a synthetic resin, or is composed of glass fibers and/or a synthetic resin. The insulator layer 132 may be composed, for example, of glass-fiber reinforced synthetic resin (glass-fiber reinforced epoxy), or have glass-fiber reinforced synthetic resin. The glass fibers in this case may be impermeable to electrons, and in this way effect electrical insulation.

According to FIG. 1a, there are three anode layers 133, 134, 135 contained in the energy storage structure 130. It is understood that there may also be only one or two, or also four or even more, anode layers 133, 134, 135 disposed in the energy storage structure 130 of anode layers 133, 134, 135.

At least one anode layer 133, 134, 135, preferably all of the anode layers 133, 134, 135, may have carbon fibers and/or a synthetic resin. In preferred embodiments, at least one anode layer 133, 134, 135 is composed (or all of the anode layers are composed) of carbon-fiber reinforced synthetic resin, or has a carbon-fiber reinforced synthetic resin. The synthetic resin of the at least one anode layer 133, 134, 135, in particular the carbon-fiber reinforced synthetic resin, may be realized, in particular, with lithium-ion-conducting properties, i.e., as an electrolyte.

The housing 110 may be cuboidal or cylindrical, e.g., circular-cylindrical in shape. The connection means 121, 123, 125 may advantageously be realized such that the plate-type energy storage elements 122, 124, 126 can be connected to the connection means 121, 123, 125 in the housing 110. The plate-type energy storage elements 122, 124, 126 may be disposed, in particular, parallel to side walls of a cuboidal housing 110, as illustrated in the left half of FIG. 1.

The plate-type energy storage elements 122, 124, 126 may be, for example, laminated energy storage structures, which may be realized as described above in relation to the laminated energy storage structure 130. In this case the plate-type energy storage elements 122, 124, 126 may be realized according to the same described variant as the laminated energy storage structure 130 itself, or according to another described variant. For example, the laminated energy storage structure 130 may comprise more or fewer, or differently realized, anode layers 133, 134, 135 as the plate-type energy storage elements 122, 124, 126.

The individual energy storage elements 122, 124, 126 may all be realized so as to be the same, or may differ from one another. The energy storage capacities of the individual energy storage elements may differ from one another.

It is preferred that the laminated energy storage structure 130 be realized such that it tends to be more robust, i.e., more resistant, and thus closer to a pure structural element than the plate-type energy storage elements 122, 124, 126, which, in comparison, may be realized such that they are closer to pure energy storage elements, i.e., having a higher energy storage density. In this way, both the laminated energy storage structure 130 of the housing 110 and the energy storage elements 122, 124, 126 disposed therein contribute to the maximally storable energy quantity, with the laminated energy storage structure 130, as a housing 110, having an additional protective function for the energy storage elements 122, 124, 126 disposed on the inside and/or an additional function as a structural element.

The connection means 121, 123, 125 themselves may also be realized so as to be substantially plate-type, the connection means 121, 123, 125 being able to be fitted parallel to one another in the housing 110. Advantageously, the plate-type connection means 121, 123, 125 are also disposed parallel to the side walls of the cuboidal housing 110, in particular, in addition parallel to the plate-type energy storage elements 122, 124, 126. In this way, the connection means 121, 123, 125 may be regarded as flanges of a structural element, and the side walls of the cuboidal housing 110 as webs of the structural element, and overall a greater structural strength of the housing 110 can be achieved.

For the purpose of charging and/or discharging the laminated electrical energy storage structure 130 and/or the energy storage elements 122, 124, 126 or groups of energy storage elements (via the connection means 121, 123, 125), the housing 110 may have electrical connections or be connected to electrical connections. Electrical lines may be realized between the laminated electrical energy storage structure 130 and one, more or all connection means 121, 123, 125. Alternatively, electric circuits of the connection means 121, 123, 125 may also be realized inside the energy storage system, completely separated from electric circuits of the laminated energy storage structure 130, such that the laminated energy storage structure 130 can be used as an emergency power source if one or more of the energy storage elements 122, 124, 126 fail, or vice versa.

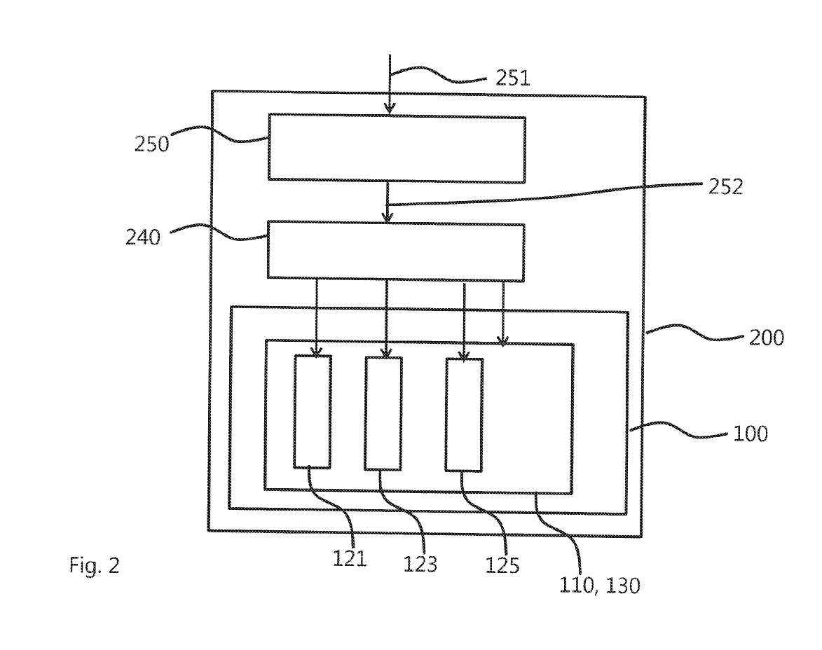

FIG. 2 shows a schematic block diagram of an energy storage system 200 according to a further embodiment of the present invention. The energy storage system 200 advantageously comprises all elements of the energy storage system 100 according to FIG. 1. In addition, the energy storage system may comprise a switching means 240 and a control means 250.

The switching means 240 is realized such that, by means of the switching means 240, the at least one connection means 121, 123, 125 can be connected both electrically in parallel and electrically serially, i.e., in series, to the laminated energy storage structure 130. In the case of the exemplary embodiment shown in FIG. 1 and FIG. 2 having, exemplarily, three connection means 121, 123, 125, the switching means 240 may be designed, for example, to realize the following switching positions:

laminated energy storage structure 130 and all connection means 121, 123, 125 individually in parallel to one another;

laminated energy storage structure 130 in series to all three connection means 121, 123, 125;

laminated energy storage structure 130 in parallel to a series connection of all three connection means 121, 123, 125;

laminated energy storage structure 130 in series to a first connection means 121, while these two elements are connected in parallel both to a second connection means 123 and to a third connection means 125;

laminated energy storage structure 130 in series to the first connection means 121, while these two elements are connected in parallel to a series connection of the second connection means 123 to the third connection means 125;

laminated energy storage structure 130 in series to the first and the second connection means 121, 123, while these three elements are connected in parallel to the third connection means 125;

the three above switching positions with all possible permutations of the first, second and third connection means 121, 123, 125.

It may also be provided that the switching means 240 can realize only some of the stated switching positions, for example only two switching positions: either a complete parallel connection of the laminated energy storage structure 130 and all energy storage elements 122, 124, 126, or a complete series connection of the laminated energy storage structure 130 to all energy storage elements 122, 124, 126.

The switching means 240 may be realized, for example, as a switching network having power-electronics elements, switches, transistors, relays and the like. The switching means 240 may also be realized as an integrated circuit, in particular as an application-specific integrated circuit (ASIC).

The switching means 240 can be controlled by a switching signal 252 for switching over between the possible switching positions of the switching means 240. The switching signal 252 may be emitted by an external control unit and reach the switching means 240, for example, via a data bus. If the energy storage system 200 is installed, for example, in a vehicle, for instance an aircraft or spacecraft, the switching signal 252 may be received by a data bus of the vehicle.

The energy storage system 200 may furthermore have a control means 250, by means of which the switching means 240 can be controlled on the basis of an input signal 251, which preferably indicates a demand for current and/or voltage. The input signal 251 may be emitted by an external control unit and reach the control means 250, for example, via a data bus. If the energy storage system 200 is installed, for example, in a vehicle, for instance an aircraft or spacecraft, the input signal 251 may be received by a data bus of the vehicle and indicate a demand of the vehicle for current and/or voltage, e.g., a demand of a motor, or air-conditioning system for current and/or voltage, and/or an overall demand of the vehicle for current and/or voltage.

The control means 250 may be designed to generate the switching signal 252 on the basis of the received input signal 251 and to control the switching means 240 with the switching signal 252. The control means may be realized, for example, as a computer, a microcontroller, a controller, as a field programmable gate array (FPGA), or as another programmable or programmed logic circuit.

The switching signal 252 is preferably generated by the control means 250 such that, in the switching position that is assumed by the switching means 240 on the basis of this switching signal 252, an electric current and/or a voltage, that corresponds to or exceeds the demand for current and/or voltage indicated by the control signal 251, is delivered by the totality of the laminated energy storage structure 130 and all energy storage elements 122, 124, 126.

A method for operating an energy storage system 100; 200 may comprise the step, switching the switching means 240 in such a manner that the switching means 240 assumes any desired switching position, e.g., of the above-mentioned switching positions. In particular, the method may comprises such a switching of the switching means 240 that at least one connection means 121, 123, 125 (or also all connection means 121, 123, 125) are connected electrically in parallel to the laminated energy storage structure 130, and additionally comprise such a switching of the switching means 240 that the at least one connection means 121, 123, 125 is connected electrically in series to the laminated energy storage structure 130, wherein the one or the other switching may be effected, for example, in dependence on the input signal 251.

The method for operating the energy storage system 100; 200 may additionally provide the setting of a discharging mode, in which electrical energy is drawn from the laminated energy storage structure 130 and/or from electrical energy storage elements 122, 124, 126 connected to the at least one connection means 121, 123, 125. The method may optionally furthermore provide the setting of a charging mode, in which electrical energy is supplied to the laminated energy storage structure 130 and/or to electrical energy storage elements 122, 124, 126 connected to the at least one connection means 121, 123, 125, for the purpose of electrically charging the laminated energy storage structure 130 or the energy storage elements 122, 124, 126. The control means 250 may be designed or set up to set the discharging mode and/or the charging mode, for example on the basis of the input signal 251.

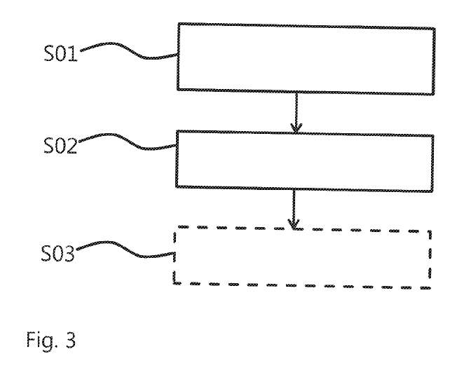

FIG. 3 shows a schematic flow diagram to explain a method for producing the energy storage system 100; 200 according to a further embodiment of the present invention. In a step S01 a housing 110 is provided that has a laminated energy storage structure 130, for instance as described above. In a step S02 at least one connection means 121, 123, 125 for an energy storage element 122, 124, 126 or for a group of energy storage elements is disposed or fitted in the housing 110, or to the housing 110, e.g., having the previously described features. The production method may optionally comprise a step S03, in which at least one energy storage element 122, 124, 126 or a group of energy storage element is electrically and/or mechanically connected to the at least one connection means 121, 123, 125.

In the detailed description above, various features have been combined to improve the stringency of the representation in one or more examples. However, it should be clear in this case that the above description is merely illustrative, but in no sense limiting, in nature. It serves to cover all alternatives, modifications and equivalents of the various features and exemplary embodiments. In consideration of the above description, many other examples will be immediately and directly obvious to persons skilled in the art on the basis of their technical knowledge.

The exemplary embodiments have been selected and described in order to represent in the best possible manner the principles on which the invention is based and their application possibilities in practice. As a result, persons skilled in the art can optimally modify and use the invention and its various exemplary embodiments with respect to the intended application. In the claims and in the description, the terms “containing” and “having” are used as neutral concepts for the corresponding terms “comprising.” Furthermore, use of the term “a” is not intended in principle to preclude a plurality of thus described features and components.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An energy storage system, comprising:
a housing having a laminated energy storage structure; and
at least one connector, disposed in the housing, for at least one energy storage element.

2. The energy storage system according to claim 1, the laminated energy storage structure having
a cathode layer,
at least one anode layer, and
an insulator layer disposed between the cathode layer and the at least one anode layer.

3. The energy storage system according to claim 1, wherein the at least one anode layer comprises at least one of carbon fibers or a synthetic resin.

4. The energy storage system according to claim 1, wherein the cathode layer comprises a ferrite or is composed of a ferrite.

5. The energy storage system according to claim 1, wherein the insulator layer is comprises of at least one of glass fibers or a synthetic resin.

6. The energy storage system according to claim 1, further comprising: a switch, by means of which the at least one connector can be connected, both electrically in parallel and electrically in series, to the laminated energy storage structure.

7. The energy storage system according to claim 6, further comprising:
a control, by means of which the switch can be controlled on the basis of an input signal.

8. The energy storage system according to claim 7, wherein the input signal comprises at least one of a demand for current or voltage.

9. A method for operating an energy storage system according to claim 6, comprising at least one of the steps:
switching the switch to connect electrically in parallel the at least one connector to the laminated energy storage structure; or
switching the switch to connect electrically in series the least one connector to the laminated energy storage structure.

10. A method for producing an energy storage system, comprising the steps:
providing a housing having a laminated energy storage structure; and
disposing in the housing at least one connector for at least one energy storage element.

11. The method according to claim 10, comprising the step:
connecting the at least one energy storage element to the at least one connector.
